(19) United States
(12) Patent Application Publication
(10) Pub. No.: US 2015/0291170 A1
(43) Pub. Date: Oct. 15, 2015

(54) METHOD FOR FREEING A VEHICLE BY ROCKING WHEN THE VEHICLE GOT STUCK

(71) Applicant: ZF Friedrichshafen AG, Friedrichshafen (DE)

(72) Inventors: Roland MAIR, Tettnang (DE); Marcus HAUG, Friedrichshafen (DE); Florian SCHNEIDER, Lindenberg im Allgau (DE); Andreas HEINZLER, Ravensburg (DE)

(21) Appl. No.: 14/684,563

(22) Filed: Apr. 13, 2015

(30) Foreign Application Priority Data
Apr. 14, 2014 (DE) 10 2014 207 117.8

(51) Int. Cl. B60W 30/18

(52) U.S. Cl. CPC B60W 30/18045; B60W 2520/105; B60W 2520/14

(57) ABSTRACT

A method for releasing a vehicle from a recognized stuck condition including initiating a rocking-free process which is continued until the rocking-free process is automatically discontinued. The rocking-free process is discontinued after the registration and persistence of a vehicle movement for a predetermined time span while, at the same time, vehicle acceleration is registered for the predetermined time span, the extremes of the acceleration during the time span lie within a band-width-limited vehicle acceleration function range whose limits correspond almost to the global extremes of the vehicle's acceleration, or after reaching and maintaining or exceeding a vehicle speed limit value for a predetermined time span and reaching or exceeding a steering path limit value during the predetermined time span, or after the activation of a door switch which was inactive before the beginning of the rocking-free process and maintaining the switch active for a predetermined time span.

This application claims priority from German patent application serial no. 10 2014 207 117.8 filed Apr. 14, 2014.

### FIELD OF THE INVENTION

The invention concerns a method for releasing a vehicle that is stuck, by means of a rocking-free process.

### BACKGROUND OF THE INVENTION

In certain weather conditions or poor road conditions it is possible for a vehicle to become stuck, for example in a depression or on slippery subsoil, so that the stuck position can no longer be left by driving off in a conventional manner. By starting off toward the obstacle, then disengaging the clutch, allowing the vehicle to roll back, and then repeating the procedure, a driver with a manual-shift vehicle can build up momentum and release the vehicle. This process is known as rocking free. For vehicles having an automatic transmission, an automated transmission or a multiple-clutch transmission the method described above can only be used in some circumstances. Such vehicles are therefore often provided with an automatic method for rocking free, which enables the vehicle to be released from its stuck position.

The rocking-free process is either initiated by a driver, or automatically started in accordance with previously stored criteria such as a large difference between the speeds of the individual wheels. The driver can often activate the automatic initiation of the rocking-free process by means of a switch or by actuating a key, so that the rocking-free process is only started when the driver so wishes. Once the vehicle has been released, the rocking-free process is terminated, for example by actuating the switch or key again.

DE 10 2004 017 422 A1 describes a method for implementing a rocking-free function, which in order to initiate the rocking-free process evaluates the wheel rotational speeds of the driven wheels of a vehicle. From that, the traction capacity of the corresponding wheels is estimated. Furthermore, among other things information about rotational direction and inclination is used in order to optimize the rocking-free process. The rocking-free function can either be activated when a driver of the vehicle actuates a switch or key, or by a command from the on-board computer. Likewise an actuation is disclosed, which after registering that the vehicle is stuck, proceeds automatically or after questioning the driver. The rocking-free process is terminated when the driver actuates the switch or key, or automatically if vehicle-internal systems register that the vehicle is moving in one direction or over a fixed distance for a longer time. It is also disclosed that in vehicles having a distance-warning system, it is tested whether sufficient free areas exist around the vehicle concerned, to carry out the rocking free. If this is not the case, the rocking-free process is suppressed.

DE 101 28 853 A1 describes a method for rocking free and/or maneuvering a vehicle with a multiple-clutch transmission, in which the rocking-free process can only be started when the clutch arrangement is in a disengaged condition and/or the vehicle concerned is at rest. In addition it is disclosed that this special transmission condition can be produced by a driver of the vehicle by means of an operating arrangement which, for example, can consist of two switches or an operating lever. The vehicle's shift lever can also serve as the operating lever. The rocking-free process is initiated when the wheel-slip of the vehicle's driven wheels or the force acting in opposition to the drive torque of the vehicle exceed a predetermined limit value, or when the vehicle's speed falls below a set limit value. A rocking-free process ends when the vehicle comes to a standstill, or when the wheel-slip becomes too great.

Furthermore, vehicles with an automated transmission are also known, which have a rocking-free function. An implemented rocking-free process is activated by a driver by means of a key and the simultaneous engagement of the first or second reverse gear, or by engaging the first to the eighth forward gear while at the same time driving more slowly than a speed of 5 km/h. The rocking-free function is deactivated either if the driver actuates the key again, or by driving at a speed above or equal to 8 km/h.

For example, if a vehicle has become stuck on muddy ground and a rocking-free function is started in order to release the vehicle, it can happed after a successful release of the vehicle that the rocking-free function is not terminated. For example, the driver of the vehicle can forget to switch off the rocking-free function by actuating the switch or key. The result is that each time the vehicle starts off a rocking-free function is initiated. This makes starting uncomfortable for the driver and can lead to accidents. The same situation arises when speed or distance limits are chosen too high or are determined erroneously. It is therefore appropriate to establish further criteria that bring about a suppression of the rocking-free process, so that the rocking-free function is carried out safely by virtue of the automatic suppression.

### SUMMARY OF THE INVENTION

The purpose of the present invention is to provide an improved method for releasing a stuck vehicle, which by implementing an automatic suppression on the basis of pre-established criteria, prevents erroneous operation by a driver and prevents the continuation of the rocking-free process after the vehicle has already been released successfully. This allows the driver, once the vehicle has been released, to drive on comfortably even if he has forgotten to actively terminate the rocking-free function.

Starting from the prior art described at the beginning, the present invention proposes a method for releasing a stuck vehicle, in which method the stuck situation of the vehicle is recognized, a rocking-free process is initiated and the process is continued until it is automatically suppressed.

A vehicle is considered to be stuck when it is in a position in which a driver cannot move the vehicle in a desired direction starting from the position, because the wheel-slip of one or more vehicle wheels is too severe, i.e. the static friction of the wheels is too low because of the condition of the subsoil.

If the wheel-slip of the vehicle is detected by sensors and evaluated, for example by evaluating the speeds of the individual wheels compared with one another, appropriate software can deduce a stuck situation and automatically initiate a rocking-free process. Alternatively the driver may perceive that the vehicle is stuck and therefore initiate the rocking-free process himself.

In this context, a rocking-free process is defined as a process for releasing a vehicle from a stuck position. During this the vehicle is first moved in a desired travel direction until a reversal point is reached. At that point there is a force equilibrium between a drive torque and a force opposing the drive torque, so that the vehicle cannot be moved beyond the point. When the reversal point is reached, the vehicle is moved in the direction opposite to the desired travel direction until another reversal point is reached, at which there is again a force equilibrium. The vehicle is then again moved in the desired travel direction until a further reversal point is reached. This reversal point is farther away from the starting position than the first reversal point. That process of rocking to and fro can be repeated as many times as necessary for the vehicle to be released from the stuck position when the drive torque of the vehicle is large enough to move the vehicle in the desired travel direction. In other words, the vehicle has then gone beyond the point of force equilibrium, i.e. an escape point from the stuck situation is opposite the previous reversal point. The movement of the vehicle in the direction opposite to the desired travel direction can take place either actively by an acceleration process, or passively for example by virtue of rolling back under gravity.

The rocking-free process is continued until it is suppressed. This means that the rocking-free process is stopped either when it has been taking place for a long enough time, for example after a successful release of the vehicle, or directly after its initiation, i.e. after a very short time, when the rocking-free process has only been operating for a fraction of a second.

The suppression of the rocking-free process takes place automatically. Here, ‘automatically’ means that when predetermined, vehicle-specific conditions arise, the rocking-free process can be suppressed automatically by vehicle-internal processes.

A first embodiment variant of the method according to the invention is characterized by the registering of a vehicle movement and the persistence of that movement for a predetermined time span. This means that by means of sensors on the vehicle a vehicle movement is determined, which persists for the predetermined time span. That can be done, for example, by detecting a vehicle speed, by registering a rotational speed of the respective wheels of the vehicle, or by determining a rotational speed of a transmission output shaft.

Furthermore, the method is characterized by the registering of vehicle acceleration for the predetermined time span, whose extremes lie for the predetermined time span within a band-width-limited vehicle acceleration function range whose limits correspond almost to the global extremes of the vehicle's acceleration. This criterion applies during the same predetermined time span as the persistence of the vehicle movement of the vehicle to be released.

Here, the time span is defined as a time interval delimited by a time span start value and a time span end value. The time span between the time span start and end values is the predetermined time span. Depending on the type of vehicle, the time span can be determined individually and even a minimal predetermined time span of zero seconds can be possible. If the predetermined time span chosen is the minimum possible, then the rocking-free process is suppressed automatically by vehicle-internal processes as soon as the previously defined vehicle-specific conditions occur.

While the rocking-free process is in operation the function of the vehicle acceleration over time has distinct extremes and fluctuates between the positive and negative extremes. During the rocking-free process the global extremes of the vehicle acceleration function are reached, i.e. the vehicle acceleration adopts a maximum and a minimum value, which are the most extreme such values when the whole of the vehicle acceleration function is examined. If the vehicle is successfully released, these fluctuations decrease and the vehicle acceleration values are quantitatively lower than the global extremes. The vehicle acceleration function, however, can have local extremes but these have quantitatively smaller values than the global extremes.

During the predetermined time span, the extremes of the vehicle acceleration lie within the band-width-limited vehicle acceleration function range, whose limits correspond virtually to the global extremes of the vehicle acceleration. The band-width-limited vehicle acceleration function range is defined as a range delimited by a positive and a negative vehicle acceleration. The limits, i.e. the limit values of the band are quantitatively close to the global extremes of the vehicle acceleration function, whereby those vehicle acceleration values are excluded which occur during the releasing of the vehicle.

If the rocking-free process is in progress and if during it the vehicle movement is registered and then maintained or exceeded for the predetermined time span and if, during that time span, the vehicle acceleration lies within the band-width-limited vehicle acceleration function range for the predetermined time span, the rocking-free process is stopped. In addition or alternatively, if the persistence of the vehicle movement described earlier occurs with a simultaneous occurrence of vehicle acceleration values within the band-width-limited vehicle acceleration function range, the starting of a rocking-free process sequence can be blocked. In other words, for example after the driver has called for it the rocking-free process can immediately be terminated again. The block can last until the vehicle speed falls below the limiting speed value. The vehicle speed and the vehicle acceleration of the vehicle to be released are determined and evaluated by the usual on-board sensors.

In a further embodiment variant of the method according to the invention, for the automatic discontinuation of the rocking-free process it is first necessary for the limit value of the vehicle's speed to be reached and then to be maintained or exceeded for the predetermined time span. Depending on the type of vehicle, the time span can be determined individually and even a minimal predetermined time span of zero seconds can be possible. Furthermore, the limit value of the vehicle's speed is set in such manner that vehicle speed values that usually occur during the rocking-free process are below the limit value. In this way erroneous suppression of the rocking-free process is prevented.

This embodiment variant is characterized by the reaching of a steering path limit value and maintaining or exceeding the steering path limit value for the predetermined time span. This criterion applies during the same predetermined time span as the persistence of the vehicle movement of the vehicle to be released.

In this case a steering path is defined as a radial deflection of a steering-wheel of the vehicle to be released from its rest position. The rest position of the steering-wheel is the position of the steering-wheel of the vehicle to be released in which it is when no force acts upon it. In the rest position of the steering-wheel, the wheels steered by the wheel are in a parallel and straight position relative to the vehicle to be released.

If the rocking-free process is in progress and if during it the limit value of the vehicle's speed and the limit value of the steering path of the steering-wheel of the vehicle to be released are reached and then maintained or exceeded for the predetermined time span, the rocking-free process is stopped. In addition or alternatively, if the limit values of the vehicle's speed and the steering path described earlier are reached or exceeded for the predetermined time span, then starting of a rocking-free process sequence is blocked. In other words, for example after the driver has called for it the rocking-free process can be terminated again immediately. The block can last until the vehicle's speed falls below the limiting speed value. The vehicle's speed is determined and evaluated by means of the usual on-board sensors. The steering path can be detected and evaluated using the data from a usual steering-angle sensor.

According to a further embodiment variant of the method according to the invention, the rocking-free process is suppressed after the activation of at least one door switch of the vehicle that was inactive before the beginning of the rocking-free process, and if the door switch remains active for a predetermined time span. The at least one door switch of the vehicle registers the opening and closing of a door of the vehicle to be released. In this case the at least one door switch is inactive when the door is closed and active when the door is open.

At the beginning of the rocking-free process the at least one door switch is inactive, i.e. the door is closed. If the rocking-free process is activated and during it the door associated with the at least one door switch is opened, the door switch is activated. The rocking-free process is stopped if the door switch remains activated for the predetermined time span. Depending on the type of vehicle, the time span can be determined individually and even a minimal predetermined time span of zero seconds can be possible. In addition or alternatively, if the condition described earlier occurs for the predetermined time span, the starting of a rocking-free process sequence can be blocked. In other words, for example after the driver has called for it the rocking-free process can be terminated again immediately. The block can last until the door switch is inactivated.

Further characteristics and advantages of the invention emerge from the following description of example embodiments of the invention, with reference to the figures and drawings which show details essential to the invention, and from the claims. In any embodiment variant of the invention the individual characteristics can be implemented individually as such, or more than one at a time, in any combination.

### BRIEF DESCRIPTION OF THE DRAWINGS

Various example embodiments and details of the invention are described in more detail with reference to the figures explained below, which show:

FIGS. 1 and 1A: A sequence function of a method for releasing a stuck vehicle, according to an example embodiment relating to a vehicle speed and a vehicle acceleration,

FIGS. 2 and 2A: A sequence function of a method for releasing a stuck vehicle, according to an example embodiment relating to a steering path of the vehicle,

FIG. 3: A sequence function of a method for releasing a stuck vehicle, according to an example embodiment relating to a door switch of the vehicle.

### DETAILED DESCRIPTION OF THE PREFERRED EMBODIMENTS

In the following description of example embodiments of the present invention, the same or similar indexes are used for the same or similar elements shown in the various figures, so that there is no need for repetitive detailed descriptions of the elements.

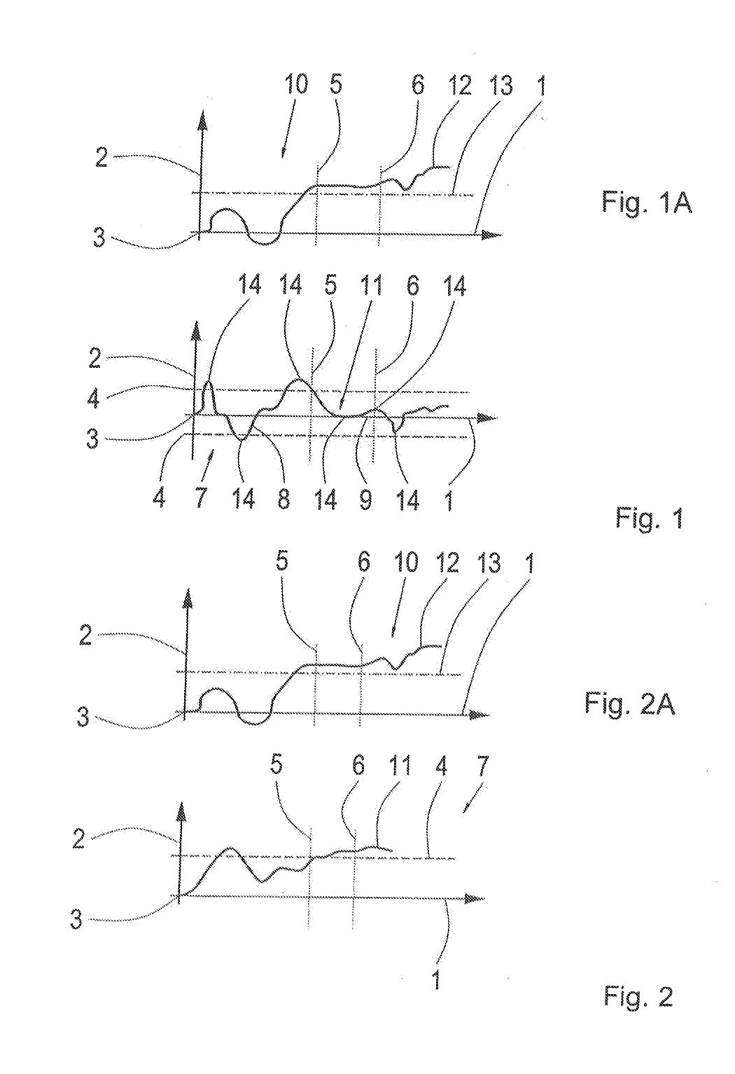

FIGS. 1 and 1A show a function sequence of a method for releasing a stuck vehicle, according to an example embodiment that relates to a vehicle speed and a vehicle acceleration. The figures show a coordinate system 7 and a further coordinate system 10, each with an abscissa 1 and in each case an ordinate 2 rising perpendicularly therefrom, the abscissa 1 and the ordinate 2 intersecting at a respective origin 3. In both coordinate systems 7, 10 the abscissa 1 represents a time axis with time increasing in the positive direction, the time scale being the same in both of the coordinate systems 7, 10. In both coordinate systems the origin 3 is a starting point at which consideration of the function sequence begins, i.e. a zero-time point.

The ordinate 2 of the coordinate system 7 represents the values of the vehicle's acceleration, which increase from a negative region toward a positive region in the positive direction of the ordinate 2 of the coordinate system 7. The origin 3 of the coordinate system 7 represents a zero value of the vehicle acceleration. The ordinate 2 of the other coordinate system 10 shows values of the vehicle's speed, which increase from a negative region toward a positive region in the positive direction of the ordinate 2 of the other coordinate system 10. The origin 3 of the other coordinate system 10 represents a zero value of the vehicle's speed.

Two limit values 4 extend in the coordinate system 7, each as a straight line, shown as broken lines parallel to and a distance away from the abscissa 1 of the coordinate system 7, these limit values 4 delimiting an intermediate area in the positive and negative directions of the ordinate 2 of the coordinate system 7. The limit values 4 visualize a vehicle acceleration function range of the vehicle to be released, which excludes all vehicle acceleration values close to the extremes of the vehicle acceleration. Moreover, a time span start value 5 extends in the coordinate system 7 as a straight line, shown as a dotted line, parallel to and a distance away from the ordinate 2 of the coordinate system 7. A time span end value 6, shown as a dotted straight line, extends in the coordinate system 7 parallel to and a distance away from the origin 2. An area between the time span start 5 and end 6 values of the coordinate system 7 is a time zone that visualizes the predetermined time span.

The coordinate system 7 shows a function 11. The function 11 represents the vehicle acceleration as a function of time and has the value zero at the starting point, namely the origin 3 of the coordinate system 7. The function 11 is divided into two sections 8, 9 which merge one into the other. A first function section 8 is characterized by several extremes 14 following one another at short time intervals. The first function section 8 exceeds the limit values 4 in both the negative and positive range of the coordinate system 7, i.e. its extremes lie outside the vehicle acceleration range delimited by the limit values 4. A second function section 9 follows on directly from the first function section 8. The second function section 9 is characterized by extremes 14 that lie within the vehicle acceleration range delimited by the limit values 4.

Moreover, there is a further limit value 13 in the other coordinate system 10. The further limit value 13 is in the form of a straight line represented by a dot-dash line parallel to and a distance away from the abscissa 1 of the other coordinate system 10. The further limit value 13 visualizes a set limiting speed value of the vehicle to be released.

In the second coordinate system 10, a time span start value 5 and a time span end value 6, each represented by a dotted line, extend parallel to and a distance away from the ordinate 2 of the second coordinate system 10. Moreover the time span end value 6 of the second coordinate system 10 is a distance away from the time span start value 5 thereof, the time span start value 5 being closer to the ordinate 2 of the second coordinate system 10 than is the time span end value 6. A region between the time span start 5 and end 6 values in the second coordinate system 10 is the time zone that visualizes the predetermined time span, and it can be seen that the time zones in the respective coordinate systems 7, 10 coincide.

There is a further function 12 in the second coordinate system 10, which represents the vehicle's speed as a function of time. For short times, i.e. close to the ordinate 2 of the second coordinate system 10, the further function shows fluctuations which, however, are in each case below the further limit value 13. At longer times there are no longer fluctuations of the further function 12, which increases steadily until the further limit value 13 is exceeded at a certain time. From that time onward the further function 12 no longer falls below the further limit value 13. Within the time zone between the time span start 5 and end 6 values of the second coordinate system 10, the further function 12 shows a lower rate of increase than outside the time zone. Within the time zone the further function 12 is almost parallel to the abscissa 1.

The release of the vehicle by a rocking-free process begins at the starting time represented by the origin 3 in both coordinate systems 7, 10. At that time the vehicle has zero speed and zero acceleration, as shown by the function 11 and the further function 12. During the rocking-free process, directly after the beginning and for a short time the vehicle is moved in one direction and then in an opposite direction and is accelerated sharply, so that the limit value 4 is exceeded by the function 11, the further function 12 being below the further limit value 13, and the functions 11 and 12 show marked fluctuations.

During the rocking-free process, as soon as the vehicle's speed represented by the function 12 shows smaller fluctuations than in the time interval after the beginning of the rocking-free process, i.e. the vehicle speed becomes nearly constant, the vehicle's speed is above the further limit value 13, the vehicle acceleration represented by the function 11 shows smaller fluctuations than in the time interval after the beginning of the rocking-free process and the vehicle acceleration remains exclusively within the range delimited by the limit values 4, the time span start value 5 is set. The predetermined time span continues until the time span end value 6. If during the predetermined time span the acceleration remains exclusively within the vehicle acceleration function range delimited by the limit values 4 and the vehicle's speed maintains or exceeds the limiting speed value shown by the further limit value 13, then from the time span end value 6 the rocking-free process is discontinued.

FIGS. 2 and 2a show a function sequence of a method for releasing a stuck vehicle according to an example embodiment that relates to a steering path of the vehicle. The figures show a coordinate system 7 and a second coordinate system 10, each with an abscissa 1 and an ordinate 2 perpendicular thereto, the abscissa 1 and the ordinate 2 in each case intersecting at a corresponding origin 3. In both coordinate systems 7, 10 the abscissa 1 represents a time axis with time increasing along the positive direction, the same time scale being shown in both coordinate systems 7, 10. In both coordinate systems 7, 10 the origin 3 represents a starting point at which the consideration of the function sequence begins, i.e. a zero-time point.

The ordinate 2 of the coordinate system 7 represents the values of the steering path of the steering-wheel of the vehicle to be released, which increase from the origin 3 in the positive direction of the coordinate system 7. The origin 3 of the coordinate system 7 represents a zero value of the steering path. The ordinate 2 of the second coordinate system 10 represents the values of the vehicle's speed, which increase from a negative range to a positive range in the positive direction of the ordinate 2 of the second coordinate system 10. The origin 3 of the second coordinate system 10 represents a zero value of the vehicle's speed.

In the coordinate system 7 a limit value 4 is in the form of a straight line, shown as a broken line, which is parallel to and a distance away from the abscissa 1 of the coordinate system 7. The limit value 4 visualizes a predetermined steering path limit value for the vehicle to be released. In addition, in the coordinate system 7 there is a time span start value 5 in the form of a straight line, shown as a dotted line, parallel to and a distance away from the ordinate 2 of the coordinate system 7. There is also a time span end value 6 in the coordinate system 7, shown as a dotted line parallel to and a distance away from the ordinate 2. A region between the time span start 5 and end 6 values represents a time zone that visualizes a predetermined time span.

In the coordinate system 7 there is a function 11. This function 11 represents the steering path as a function of time and has the value zero at the starting point represented by the origin 3 of the coordinate system 7. The function 11 increases sharply directly after the starting point and exceeds the limit value 4 for a short time. Thereafter the function falls below the limit value 4 and then increases again above the limit value 4. After the second time that it exceeds the limit value 4, the function 11 no longer falls below it.

In addition, there is a further limit value 13 in the second coordinate system 10. The further limit value 13 is a straight line, shown as a dot-dash line, which is parallel to and a distance away from the abscissa 1 of the second coordinate system 10. The further limit value 13 visualizes a fixed limiting speed value of the vehicle to be released.

In the second coordinate system 10, a time span start value 5 and a time span end value 6, each in the form of a straight line shown as a dotted line, extend parallel to and a distance away from the ordinate 2 of the second coordinate system 10. Moreover there is a distance between the time span start 5 and end 6 values in the second coordinate system, the time span start value 5 being closer to the ordinate 2 of the second coordinate system 10 than is the time span end value 6. An area between the time span start 5 and end 6 values of the second coordinate system 10 is the time zone that visualizes the predetermined time span, and the time zone in the second coordinate system 10 coincides with the corresponding time zone in the first coordinate system 7.

There is a further function 12 in the second coordinate system 10, which represents the vehicle speed as a function of time. For short times, i.e. close to the ordinate 2 of the second coordinate system 10, the further function shows fluctuations which, however, are all below the further limit value 13. With increasing time there are no longer fluctuations of the further function 12, which increases steadily until at a certain time the further limit value 13 is exceeded. From that time onward the further function 12 no longer falls below the further limit value 13. Within the time span delimited by the time span start 5 and end 6 values of the second coordinate system 10, the further function 12 increases more slowly than outside that time zone. In the time zone the further function 12 is almost parallel to the abscissa 1.

The release of the vehicle by a rocking-free process begins at the starting time represented by the origin 3 in both coordinate systems 7, 10. At that time the vehicle's speed is zero and the steering-wheel of the vehicle has no steering path, as shown by the function 11 and the further function 12. During the rocking-free process the vehicle moves at a low vehicle speed directly after the beginning for a short time in one direction and then in an opposite direction, the further function 12 being below the further limit value 13 and both functions 11 and 12 showing marked fluctuations.

During the rocking-free process, as soon as the vehicle's speed represented by the further function 12 shows smaller changes than in the time interval after the beginning of the rocking-free process, i.e. when the vehicle speed is almost constant, the speed is above the further limit value 13 and the steering path represented by the function 11 is exclusively above the limit value 4, the time span start value 5 is set. The predetermined time span continues until the time span end value 6. If during the predetermined time span the steering path moves to or above the limit value 4 and the vehicle's speed persists or exceeds the limiting speed value represented by the further limit value 13, then from the time span end value 6 the rocking-free process is discontinued.

FIG. 3 shows a function sequence of a method for releasing a stuck vehicle according to an example embodiment that relates to a door switch of the vehicle. The figure shows a coordinate system 7 with an abscissa 1 and an ordinate 2 perpendicular thereto, the abscissa 1 and the ordinate 2 intersecting at an origin 3. The abscissa 1 represents a time axis with time increasing in a positive direction. The origin 3 is a starting time at which a consideration of the function sequence begins, i.e. a zero-time point.

In the coordinate system 7 defined by the abscissa 1 and the ordinate 2 there is a limit value 4 in the form of a straight line shown as a broken line, which is parallel to and a distance away from the abscissa 1. The limit value 4 visualizes an active condition of the door switch of the vehicle to be released. In addition, in the coordinate system 7 defined by the abscissa 1 and the ordinate 2, a time span start value 5 is represented by a straight, dotted line parallel to and a distance from the ordinate 2. In the coordinate system 7 defined by the abscissa 1 and the ordinate 2, a time span end value 6 is also represented by a dotted line parallel to and a distance away from the ordinate 2, the time span start value 5 being closer to the ordinate 2 than is the time span end value 6. An area between the time span start 5 and end 6 values visualizes a time zone corresponding to a predetermined time span.

In the coordinate system 7 defined by the abscissa 1 and the ordinate 2, a function 11 extends a distance away from the abscissa 1 and very substantially parallel thereto. The function 11 is divided into two sections 8, 9, which connect one with the other at a rising step. A first function section 8 is a straight-line section which extends a distance away from the abscissa 1 and the limit value 4 in the coordinate system 7 defined by the abscissa 1 and the ordinate 2. The first function section 8 extends closer to the abscissa 1 than is the limit value 4 and visualizes an inactive condition of the door switch of the vehicle to be released. A second function section 9 is a straight-line section extending a distance away from and parallel to the abscissa 1 and along the limit value 4 in the coordinate system 7 defined by the abscissa 1 and the ordinate 2. This second function section 9, as also the limit value 4, visualize the activated condition of the door switch. Thus, the function 11 represents the condition of the door switch. The step-like transition between the first section 8 and the second section 9 marks the time span start value 5.

The release of the vehicle by a rocking-free process begins at the starting time, represented by the origin 3. At that time the door switch of the vehicle is inactivated, as shown by the first function section 8. If during the rocking-free process the door switch is activated, the time span start value 5 is set and the predetermined time span begins. If the door switch remains active during the predetermined time span, the rocking-free process is discontinued from the time span end value 6 onward.

The example embodiments described and illustrated in the figures are chosen only as examples. For instance, the time span start and end values can coincide so that the predetermined time span lasts zero seconds. Furthermore, for instance the example discontinuation criterion of vehicle speed in relation to the vehicle's movement can be replaced by some other vehicle movement related discontinuation criterion, such as the registration and evaluation of a respective rotational speed of the vehicle's wheels or the detection of a rotational speed of a transmission output shaft. Different example embodiments can be combined with one another completely or in relation to individual features. Also, one example embodiment can be supplemented by one or more features of another example embodiment.

### INDEXES

1 Abscissa
2 Ordinate
3 Origin
4 Limit value
5 Time span start value
6 Time span end value
7 Coordinate system
8 First function section
9 Second function section
10 Further coordinate system
11 Function
12 Further function
13 Further limit value

1-3. (canceled)

4. A method of releasing a vehicle that is stuck, the method comprising the steps of:
recognizing a stuck condition of a vehicle,
initiating a rocking-free process,
continuing the rocking-free process until the rocking-free process is discontinued automatically,
discontinuing the rocking-free process after:
vehicle movement is registered,
the vehicle movement persists for a predetermined time span, and
a vehicle acceleration is registered, whose extremes within the predetermined time span lie within a band-width-limited vehicle acceleration function range and limits of the vehicle acceleration function correspond approximately to global extremes of the vehicle acceleration.

5. A method of releasing a vehicle that is stuck, the method comprising the steps of:
recognizing a stuck condition of the vehicle,
initiating a rocking-free process,
continuing the rocking-free process until the rocking-free process is discontinued automatically,
discontinuing the rocking-free process after:
reaching a limiting speed value of the vehicle,
either maintaining or exceeding the limiting speed value for a predetermined time span,
reaching a steering path limit value, and
either maintaining or exceeding the steering path limit value for the predetermined time span.

6. A method of releasing a vehicle that is stuck, the method comprising the steps of:
recognizing a stuck condition of the vehicle,
initiating a rocking-free process,
continuing the rocking-free process until the rocking-free process is discontinued automatically,
discontinuing the rocking-free process after:
activation of at least one door switch of the vehicle, which was inactive before the initiation of the rocking-free process, and
activation of the door switch persists for a predetermined time span.
